(19) United States
(12) Patent Application Publication
(10) Pub. No.: US 2007/0208590 A1
(43) Pub. Date: Sep. 6, 2007

(54) Federated Customer Servicer Broker

(75) Inventors: Martin Rex Dorricott, Basingstoke (GB); Douglas Craig Murray Webster, Trowbridge (GB)

Correspondence Address: McGUINNESS & MANARAS LLP, 125 NAGOG PARK, ACTON, MA, 01720, US

(73) Assignee: Exony Ltd.

(21) Appl. No.: 11/680,766

(22) Filed: Mar. 1, 2007

Related U.S. Application Data
(60) Provisional application No. 60/833,840, filed on Jul. 27, 2006.
(60) Provisional application No. 60/779,211, filed on Mar. 3, 2006.

(51) Int. Cl. G06Q 10/00; G06Q 30/00

(52) U.S. Cl. 705/1

(57) ABSTRACT

An architecture for facilitating provision of service includes a primary contact center and a federated customer service broker under control of a primary business, i.e., the business on behalf of which the customer service is to be provided. The broker accepts and maintains submissions from customer service providers (“Subscribers”) indicating levels of skill in various categories. Provision of customer service is enhanced by brokering customer service inquiries between a customer and the subscribers. In particular, the broker selects a subset of available subscribers with an appropriate level of skill in the categories required to response to the customer service inquiry, and prompts presentation of customer service options associated with the selected subset of subscriber to the customer. The subscribers may be independent contractors that provide customer service in exchange for payment either from the customer or from the primary business. The subscribers may even pay the primary business for use of the brokering service in the case where the subscriber is paid by the customer.

### CROSS-REFERENCE TO RELATED APPLICATIONS

A claim of priority is made to U.S. Provisional Patent Application Ser. No. 60/833,840, entitled FEDERATED CUSTOMER SERVICE BROKER (FCSB), filed on Jul. 27, 2006, and to U.S. Provisional Patent Application Ser. No. 60/779,211, entitled A NOVEL ARCHITECTURE AND ALGORITHMS FOR MULTI-MODAL CUSTOMER SERVICE, filed on Mar. 3, 2006, both of which are incorporated by reference.

### FIELD OF THE INVENTION

This invention is generally related to the field of customer service, and more particularly to brokering customer service offerings from multiple third party providers of customer service on behalf of an enterprise.

### BACKGROUND OF THE INVENTION

Customer service is typically provided through a contact center. The current state of the art in contact center technology utilizes interactive voice response systems and skills based routing (“SBR”). Each customer service agent in the contact center is characterized according to skill values indicative of proficiency in particular skills. Call routing rules executed by a SBR engine direct customer service inquiries by matching those values with skills required to satisfy the customer inquiry, and also determine what priority “weight” to apply to particular skills, control breaking routing ties between customer service agents, and control how long to hold a caller on a must route queue before rolling over to a general call center queue. Advantages of SBR and voice response relative to earlier technologies include improved customer satisfaction because less time is wasted in call transfers until finally reaching an agent having the appropriate skills to answer the customer's questions. Call handling costs are also lowered because the number of call transfers is reduced.

Even with state of the art voice response systems and SBR, meeting customer expectations can be difficult. The widespread adoption of the internet and globalisation have lead to customers expecting immediate 24×7 service. Until relatively recently, contact centers were often staffed and operated by the same enterprise which provided the product or service that is the subject of the customer service request. For example, someone requesting customer service regarding an appliance would speak with an employee of the appliance manufacturer. However, 24×7 customer service is expensive to resource in an “insource” model unless “follow the sun” implementation is adopted, i.e., geographically diverse contact centres. Even with a “follow the sun” implementation, the distribution of service delivery inherently becomes difficult to manage because of differences in physical location, time, language and other factors. In response, 24×7 Service delivery through outsourcing has become the current trend. For example, the appliance manufacturer might contract another enterprise that specializes in customer service to handle inquiries about the manufacturer's products. This trend has encouraged development of contact center businesses in areas of the world where labor costs are relatively low, thereby resulting in cost savings. However, outsourced customer service is typically managed through service level agreements (“SLAs”), and tends to lack both agility and true integration into the current business needs of the served enterprise. Further, the served enterprise which provided the product or service must still train some of the contact center staff, and will typically be contractually obligated to the contact center business. It would be desirable, at least in some circumstances, to have greater flexibility.

### BRIEF DESCRIPTION OF THE FIGURES

FIG. 1 illustrates an architecture with a federated customer service broker that brokers customer service between a customer and multiple subscribers.

FIG. 2 illustrates a technique for initiating a brokered customer service request.

FIG. 3 illustrates an alternative embodiment of the architecture of FIG. 1.

FIG. 4 illustrates the primary contact center and federated customer service broker in greater detail.

FIG. 5 illustrates a data model.

FIG. 6 illustrates a specific contextual example of the architecture of FIG. 1.

### DETAILED DESCRIPTION

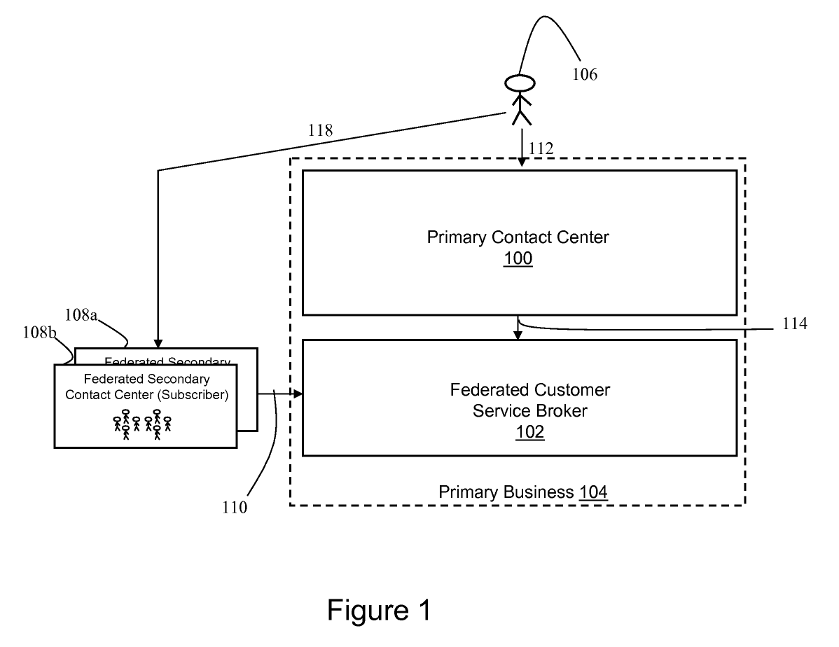

Referring to FIG. 1, an architecture for improving provision of customer service includes a primary contact center (100) and a federated customer service broker (102), both of which are under the control of a primary business (104), i.e., the business on behalf of which the customer service is to be provided. However, in an alternative embodiment the service broker (102) is externally hosted, e.g., by a third party other than the primary business (104). Provision of customer service is enhanced by brokering service offerings from a plurality of secondary contact centers (108a, 108b) to at least some customer service inquiries from a customer (106). The secondary contact centers may be subscribers to the primary business, i.e., independent contractors that provide customer service in exchange for payment either from the customer or from the primary business. The subscribers may even pay the primary business for use of the brokering service in the case where the subscriber is paid by the customer, as will be explained in greater detail below.

By enabling the use of subscribers, the broker provides the benefits of outsourced customer service, but without at least some of the disadvantages, and with some additional advantages. One advantage is that the customer can be provided greater control over the customer service event by virtue of being offered competitive choices such as selecting from multiple subscribers based on context, customer device media capability, service presence (i.e., the ability for a service request to be fulfilled with available resources such as an advisor), cost of service to the customer, and historic performance rating of the subscriber. From the perspective of the primary business, advantages are that the contact centre can become a competitive profit centre, and that SLA and performance management is regulated by the customers rather than abstract performance indicators. These and other features and advantages will be apparent from the description below.

As illustrated in FIG. 1, prior to receiving customer service inquiries the subscribers (108) subscribe to the broker (102) as indicated in flow (110). Subscription to the broker may include providing contact details, hours of availability, rates, and an indication of skill levels in various skill categories. When the customer (106) subsequently contacts the primary business (104), as indicated in flow (112), the call is received by the primary contact centre (100). In response to the call, the primary contact centre, via a contact application handling the call, consults the federated customer service broker (102), as indicated in flow (114). The broker is operative in response to the primary contact centre to return choices back to the customer as indicated in flow (116). When the customer selects one of the service choices, the call is transferred either directly or indirectly to the chosen subscriber as indicated in flow (118).

As mentioned above, the illustrated architecture will support a variety of commercial models. In one model the subscribers are authorized service centres that will pay a fee to the primary business for training and certification in particular skills. If the subscriber is selling a service to end customers then the subscriber may also pay a fee to the primary business for calls routed. The subscriber may additionally or alternatively pay a fee for services offered to the customer, regardless of whether those services are selected by the customer. Alternatively, the primary business may pay the subscribers a set fee, per call fee, per unit time fee, or other fee basis for fielding customer service inquiries on behalf of the primary business. The primary business (104) may include a network accounting module for tracking service offerings presented to the customer and service offerings actually selected by the customer to facilitate these commercial models. The accounting module may be implemented in the primary contact centre (100), the broker (102), or as a standalone device.

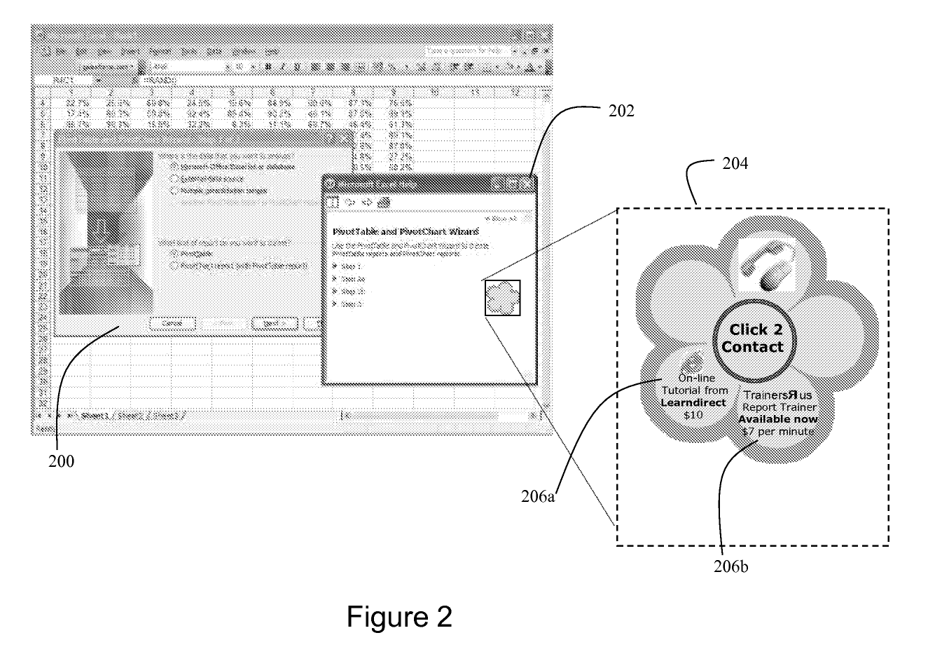

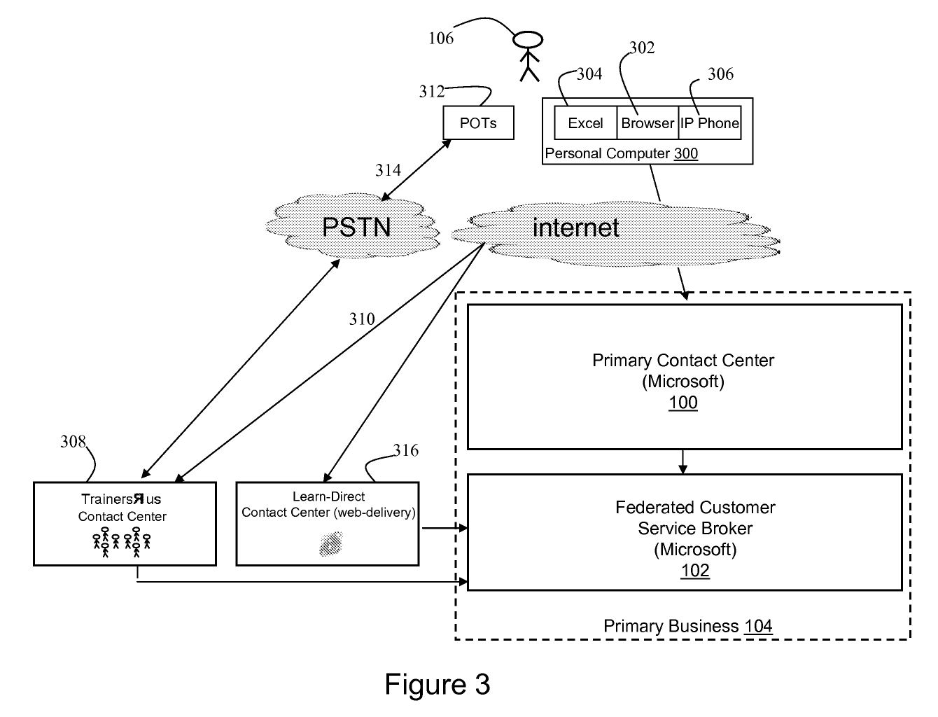

Referring to FIGS. 2 and 3, the customer (106) may initiate a customer service inquiry from a personal computer (300). In particular, the inquiry may be initiated through an application such as a browser (302), productivity application or game. In the specifically illustrated example which will be used throughout the description of FIGS. 1 through 5, the initiation of a customer service event is triggered from within the spreadsheet application Excel (304). To initiate the event the customer may press F1 in the “pivot table wizard” (200) of the Excel application running on the computer in order to obtain help on pivot tables. This action causes the application (304) to send a request to the primary business (104) (in this case, Microsoft) for potential customer service. In response, the broker (102) identifies available options and identifies those options to the Excel application. A help screen window (202) is then generated by the Excel application. The help screen window includes a service option selector icon (204) which is populated based on the information returned from the broker. In particular, the option selector icon presents service options (206a, 206b). The potential subscribers identified by the primary contact centre in this example are “learn Direct” and “TrainersRus.” The service option selector icon includes information to assist the customer in choosing one of the service options. For example, the icon may identify the offering subscribers by name. Further, in the illustrated example the service availability and media of delivery are presented, i.e., from “Learn Direct” via web for $10 flat, and from “trainersRus” via click-to-call for $7 per minute, respectively. An alternative service option and technique for presenting service options that may be utilized is an advanced speech application. For example, the speech application could be programmed to guide the customer through typical issues with pivot tables. This speech application could be executed either on the personal computer or on an application server in the primary contact centre.

Having been presented with the two service options, the customer can elect to either do: (1) nothing; (2) select TrainersRus; or (3) select Learn-Direct. If the customer selects TrainersRus, then provided the personal computer (300) is equipped with IP telephony (306), it can be directed to TrainersRus (308) seamlessly as indicated by flow (310). Preferably, this is done with the “pivot table” metadata embedded in the call initiation so that the customer does not need to put the context around the call when they speak to an advisor. Alternatively, if the customer needs to speak to the advisor using a conventional phone (312), either TrainersRus (308) is instructed via flow (310) to call-back the customer as indicated in flow (314), or the customer is given the phone number to call-back TrainersRus as indicated by flow (314). If the customer selects Learn Direct (316) then an internet browser is launched on the personal computer (300) and directed to Learn-Direct, or alternatively directed to a web-part uploaded to the primary contact centre (100). As with the IP phone, the initiation has the pivot table context communicated within it.

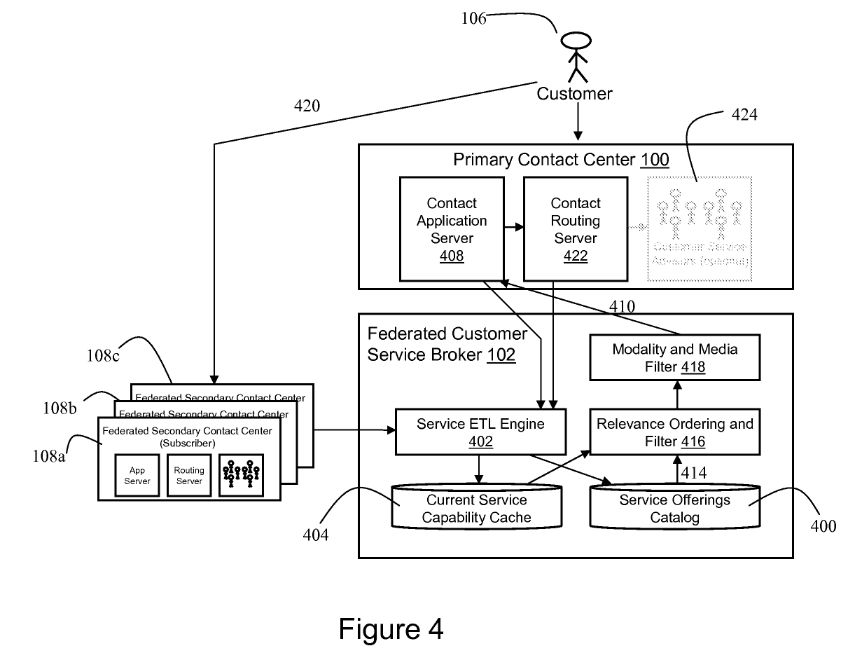

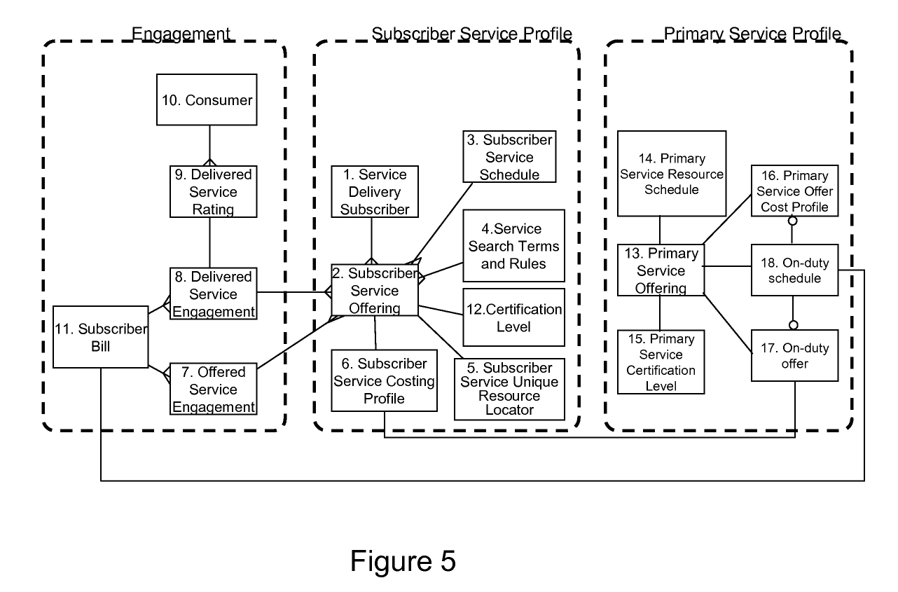

FIGS. 4 and 5 illustrate the primary contact centre and federated customer service broker and data models in greater detail. The core data that is processed by the broker is stored in the “Service Offerings Catalog” (400). The service offerings schema, as shown specifically in FIG. 5, holds a catalogue of all services that are available from subscribers together with search data and rules that provide access to them. The Service Offerings Catalog data is entered into the system both through automatic extract transform and load (via the service ETL engine (402)) and manual entry of the subscriber. The Current Service Capability Cache (404) uses the service ETL engine to remain synchronised with the current state of the service resources within each of the subscribers.

In the context of the specific example where it is expected that a resource would be available in TrainersRus to fullfil some pivot table tutoring, when the customer initiates the service request via pressing F1 within Excel as indicated by flow (406), the Contact Application Server (408) analyses the request and requests via flow (410) the broker (102) to search for a the “best” suitable services as shown by connections (412, 414). The Service Offerings Catalog (400) provides a list of subscriber services that best match the search criteria, e.g., “pivot, table, excel, help.” This is filtered and ordered by the “Relevance Ordering and Filter” process (416) that takes into account: (1) the availability of the options from the “Current Service Capability Cache;” (2) previously scored quality ratings of the service provided historically; (3) any certification criteria to deliver the resource; and (4) the quality of the search match. This filtered list of items is then further filtered by filter (418) based on the modality and media capability of the requesting device, e.g., in the illustrated example the PC has web and voice. The options are offered to the customer as already described above, and the selection made here is executed via connection (420). On completion of the service, the customer may be prompted back to the Primary Contact Centre (100) to complete a survey hosted by the primary contact centre. This gives the customer the ability to rate the service provided which is stored in the Service Offerings Catalogue shown. As already mentioned, this data may also be presented to future customers to aid in selection of a service offering. A contact routing server (422) and optional in-house customer service advisors (424) are shown for completeness.

The data model includes engagement related data, a subscriber service profile, and primary service profile. Engagement related data includes the offered service engagement, the delivered service engagement, the delivered service rating, consumer data, and subscriber bill data. A subscriber service profile includes service delivery subscriber data, the subscriber service offering, subscriber service schedule, service search terms and rules, subscriber service URL, subscriber service costing profile, and subscriber certification level. Primary service profile data includes the primary service offering, primary service resource schedule, primary service certification level, primary service offer cost profile, on-duty offer, and on-duty schedule.

Simplified examples of the core data objects are described below in accordance with the Excel help embodiment. For the service delivery subscriber (1) (federated secondary contact centre), examples include: Learn-direct and TrainersRus. For the Subscriber service offering (2) examples include: on-line tutorial for pivot tables (Learn-direct), and Report Trainers for pivot tables (TrainersRus). For the subscriber service schedule (3), examples include: 24×7 (On-line tutorial offering from Learn-direct), and 9:00 to 17:00 GMT mon-fri (Report Trainers offering from TrainersRus). For the service search terms and rules (4), examples include: {Pivot, excel, web, online} from (On-line tutorial offering from Learn-direct), and {Personal, reporting, pivot, external data} from (Report Trainers offering from TrainersRus). For Subscriber Service URL (5), examples include: {http://shop.learndirect.com/offer?pivot%20table} from (On-line tutorial offering from Learn-direct), and {SIP://trainersRus.com?pivot%20table,1-800-9876543} from (Report Trainers offering from TrainersRus). For Subscriber Service Costing Profile (6), examples include: (a) Presentation of offering $0.01 per event and (b) On-click through $0.50 per event, from (On-line tutorial offering from Learn-direct), and (c) Presentation of offering $0.75 when current service capability <=1 minute delay and office hours, else $0.02, and (d) On-click trough $0.60 per event from (Report Trainers offering from TrainersRus). For the Offered Service Engagement (7) examples include 13:00 pm on Friday 31 dec 2006, pivot table from (On-line tutorial offering from Learn-direct), and 13:00 pm on Friday 31 Dec. 2006, pivot table from (Report Trainers offering from TrainersRus). For Delivered Service Engagement (8), examples include (assuming TrainersRus is selected) 13:02 pm on Friday 31 dec 2006, pivot table from (Report Trainers offering from TrainersRus). For Delivered Service Rating (9), examples include 13:02 pm on Friday 31 dec 2006, score 7/10 (Report Trainers offering from TrainersRus to John Doe as scored through a survey filled in by John Doe). For Consumer data (10), (assuming TrainersRus is selected by John Doe) the example is John Doe. For Subscriber Bill (11), examples include: (for TrainersRus) 13:00 pm on 31 dec 2006, $0.75; 13:02 pm on 31 dec 2006, $0.60; Total $1.35; and (for Learndirect) 13:00 pm on 31 dec 2006, $0.01. For the optional Certification Level (11) of the subscriber service offering, examples include On-line tutorial for pivot tables (Learn-direct) certified gold training partner, and Report Trainers for pivot tables (TrainersRus) certified silver training partner. The certification level (12) indicates competencies as defined by the primary business. The primary service offering (13) examples include: Excel Help and pizza delivery. The primary service resource schedule (14) indicates requirements, e.g., 09:00-18:00, Monday through Saturday, and may also indicate requirements nested within ranges of the schedule, e.g., one person from 09:00-16:00 and five persons 16:00-18:00. The primary service certification level (15) indicates required subscriber knowledge, i.e., the contact centre specified requirement which would be compared with the certification level (12). The primary service offer cost profile (16) indicates the price on offer by the primary business or contact centre, and may be updated over time, e.g., increased in a rising auction until requirements are satisfied. The on-duty offer (17) indicates the offer by the subscriber, i.e., which will be compared with the service offer cost profile.

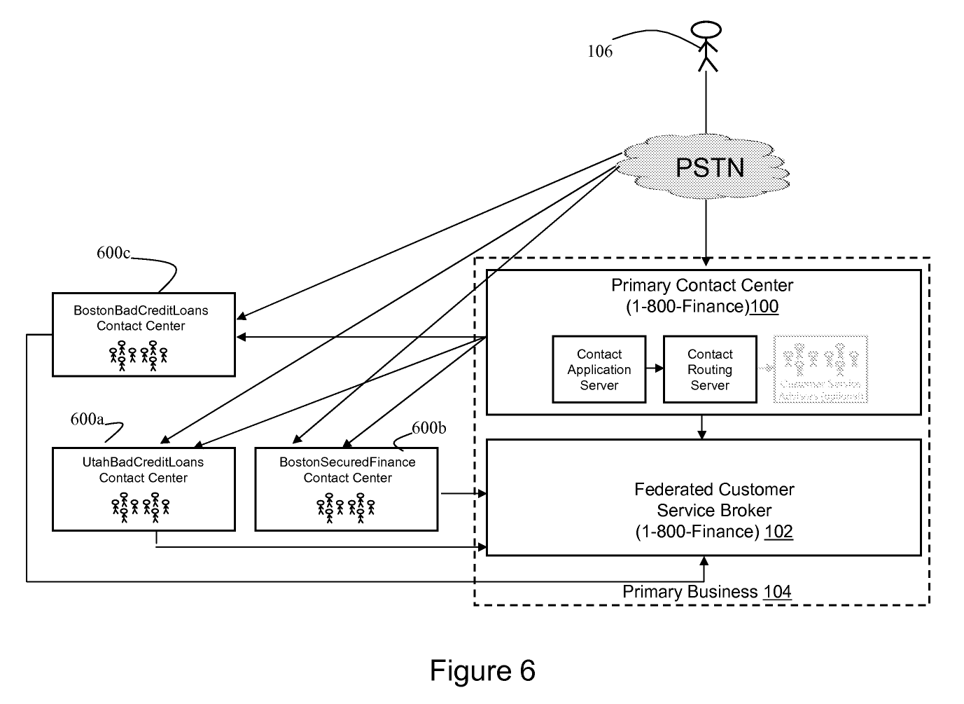

FIG. 6 illustrates an alternative example in which the architecture is utilized to facilitate a finance offering. The finance offering is presented via a 1-800-FINANCE number that is advertised to the public. In this example the subscribers (600a, 600b, 600c) are three localised specialists. One specialist, UtahBadCreditLoans (600a), has subscribed with the description “specializing in unsecured debt in the state of Utah.” Another specialist, BostonBadCreditLoans (600c), has subscribed with the description “specializing in unsecured debt in the state of Massachusetts.” Another specialist, BostonSecuredFinance (600b), has subscribed with the description “specializing in home secure loans on the east coast.” The subscribers have also set up the following search hints in a similar manner to that illustrated by FIG. 5. For UtahBadCreditLoans the search hints are {hard pressed, moderate means, utah, loans}. For BostonBadCreditLoans the search hints are {urban prosperity, comfortably off, Boston, 617, loans}. For BostonSecuredFinance the search hints are {hard pressed, moderate means, Boston, 617, loans}. The following timeline illustrates actions when a potential customer (“Caller”) calls:
1. Caller dials 1-800-Finance from the centre of Boston.
2. Caller is confronted with an advanced speech application (running on the Contact Application Server) at the primary contact centre which prompts: “What kind of financial service do you require?”
3. Caller responds aurally “Loans.”
4. The Contact Application Server issues a request to the federated customer service broker for some options, passing “loans” and the calling line ID of the Caller, e.g., 617-1234567, to provide context to the call.
5. The federated customer service broker searches its subscriptions. The search may be augmented with demographic data stored in the service offerings database
   In this example this augmented data maps 617-1234567 to the centre of Boston with the category of “urban prosperity”
6. In this example the current capability cache is as follows:
   UtahBadCreditLoans:—expected time to answer 5 seconds
   BostonBadCreditLoans:—expected time to answer 14 hours (closed until tomorrow)
   BostonSecuredFinance:—expected time to answer 1 minute.
7. The broker returns the following ordered options back to the Contact Application Server (note the number of entries in the list would be limited to a preconfigured maximum number):
   BostonSecuredFinance, who have subscribed with the following description “specializing in home secure loans on the east coast” which had three hits in the service offerings database (Loans, 617, “urban prosperity”) and is expected to service the call within a minute
   UtahBadCreditLoans, who have subscribed with the following description “specializing in unsecured debt in the state of Utah” which had one hit in the service offerings database (Loans) and is expected to service the call within a minute

### Note that BostonBadCreditLoans has an excessive answer delay so has become lower priority than UtahBadCreditLoans and fallen off the list

8. The advanced speech application converts the text to speech such that the Caller can hear these choices: “Would you like to be connected to BostonSecuredFinance, who specialize in home secure loans on the east coast, or UtahBadCreditLoans, who specialize in unsecured debt in the state of Utah”
9. The Caller may respond “BostonSecuredFinance”
10. The ASR application and contact routing server then routes the call to BostonSecuredFinance

### It will be appreciated that if a call came from a poor region in Utah requesting loans or had the BostonBadCreditLoans been on line the choices would be offered differently.

Although the embodiments of the invention have been described with respect to on-demand resourcing, a forward contract resourcing model could also be supported. On-demand resourcing is characterized by one or more of: no roster, no guarantee that a subscriber will be immediately available to provide service, and real dynamic pricing, which is suited to mass commodities and scenarios where highly specialized expertise is required only on occasion, and need not be immediate. In contrast, forward contract resourcing is typically characterized by one or more of a roster of on-duty subscribers, and dynamic (auction) pricing set ahead of resource requirement and binding. With auction pricing, subscriber agents “populate” the roster via auctioning either on a rising price which closes ahead of the scheduled start time, e.g., the day before, or a “buy-it-now” style basis with a set rate.

An example of the forward contract resourcing model is as follows. The primary business has a requirement for service support between 8:00 and 20:00 next Monday with 10 FTEs (Full time equivalents). To satisfy the requirement, a schedule of 12 slots of quantity 10 for Monday, as defined in Primary Service Resource Schedule (14) are auctioned to subscribers. Subscribers that “win” the auction to be on duty have their schedule recorded in on-duty schedule (18). Accredited Subscribers may bid in a rising price auction, which is defined in the on-duty offer (17), with their current cost profile, which is defined in the Subscriber service costing profile (6). Alternatively a published “sell-it-now” price defined in Primary service cost profile (16) allows a subscriber to accept that price and book themselves immediately to the on-duty schedule (18), thereby by-passing the auction. At a predetermined time, e.g., Sunday, the auction closes. Any parts of the remaining schedule which are left un-manned by the “sell-it now” subscribers are then populated from the first offers defined in on-duty offer (17), the order of selection being determined by Subscriber Service Costing Profile (6), e.g., the lowest cost bids in ascending order.

A duty-cycle refinement may be implemented to support the requirements of certain primary businesses. For example, a florist might expect a total of 10 minutes of orders to be taken per hour, i.e., ⅙ duty cycle. To support this requirement, the auction could be for 2× 1/12 FTEs per hour. In this case, two subscribers can schedule 1/12 units per hour, i.e., they can be allowed to book other low-duty-cycle similar commitments so that statistically they can service all their commitments.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for facilitating provision of customer service to a customer comprising:
a broker device operable to accept service offerings from multiple subscribers, including, for each subscriber, recording an indication of proficiency in different skills; and
a primary contact center operable in response to an inquiry from the customer to signal to the broker device,
the broker device being operable in response to the primary contact center to identify at least one subscriber having relatively greater proficiency than other subscribers in skills required to respond to the inquiry, and to provide to the primary contact center an indication of the identified subscribers,
the primary contact center being operable in response to the broker device to present service option information associated with the identified subscribers to the customer.

2. The apparatus of claim 1 wherein the inquiry is initiated by an application on a computer operated by the customer.

3. The apparatus of claim 1 further including an accounting module operable to track service options presented to the customer.

4. The apparatus of claim 1 further including an accounting module operable to track service options selected by the customer.

5. The apparatus of claim 2 wherein the primary contact center is further operable to prompt the application to render a help screen window having a service option selector icon populated based on the information provided by the primary contact center.

6. The apparatus of claim 5 wherein information includes an indication of service availability.

7. The apparatus of claim 5 wherein information includes an indication of fees charged to the customer for the service.

8. The apparatus of claim 5 wherein information includes an indication of media of delivery of the service.

9. The apparatus of claim 1 wherein the primary contact center is operable in response to selection of a service option by the customer to set up a telephone connection between the customer and the subscriber associated with the selected service option.

10. The apparatus of claim 1 wherein the primary contact center is operable in response to selection of a service option by the customer to provide the customer with a telephone number via which to contact the subscriber associated with the selected service option.

11. The apparatus of claim 1 wherein the primary contact center is operable in response to selection of a service option by the customer to provide the subscriber associated with the selected service option with a telephone number via which to contact the customer.

12. The apparatus of claim 1 wherein the primary contact center is operable in response to selection of a service option by the customer to provide the customer with a network address via which to contact the subscriber associated with the selected service option.

13. The apparatus of claim 1 wherein the broker device is operable to track customer rating of subscribers.

14. The apparatus of claim 5 wherein information includes an indication of rating of a subscriber by at least one previous customer.

15. The apparatus of claim 1 wherein at least one service offering includes search hint terms.

16. The apparatus of claim 16 wherein the broker device is further operable to utilize the search hint terms to identify the at least one subscriber in response to the customer inquiry.

17. A computer-readable medium encoded with a computer program for facilitating provision of customer service to a customer, comprising:
broker logic operable to accept service offerings from multiple subscribers, including, for each subscriber, recording an indication of proficiency in different skills; and
primary contact center logic operable in response to an inquiry from the customer to signal to the broker device,
the broker logic being operable in response to signaling from the primary contact center logic to identify at least one subscriber having relatively greater proficiency than other subscribers in skills required to respond to the inquiry, and to provide to the primary contact center logic an indication of the identified subscribers,
the primary contact center logic being operable in response to the broker logic to present service option information associated with the identified subscribers to the customer.

18. The computer-readable medium of claim 17 wherein the inquiry is initiated by an application on a computer operated by the customer.

19. The computer-readable medium of claim 17 further including accounting logic operable to track service options presented to the customer.

20. The computer-readable medium of claim 17 further including accounting logic operable to track service options selected by the customer.

21. The computer-readable medium of claim 18 wherein the primary contact center logic is further operable to prompt the application to render a help screen window having a service option selector icon populated based on the information provided by the primary contact center.

22. The computer-readable medium of claim 21 wherein information includes an indication of service availability.

23. The computer-readable medium of claim 21 wherein information includes an indication of fees charged to the customer for the service.

24. The computer-readable medium of claim 21 wherein information includes an indication of media of delivery of the service.

25. The computer-readable medium of claim 17 wherein the primary contact center logic is operable in response to selection of a service option by the customer to set up a telephone connection between the customer and the subscriber associated with the selected service option.

26. The computer-readable medium of claim 17 wherein the primary contact center logic is operable in response to selection of a service option by the customer to provide the customer with a telephone number via which to contact the subscriber associated with the selected service option.

27. The computer-readable medium of claim 17 wherein the primary contact center logic is operable in response to selection of a service option by the customer to provide the subscriber associated with the selected service option with a telephone number via which to contact the customer.

28. The computer-readable medium of claim 17 wherein the primary contact center logic is operable in response to selection of a service option by the customer to provide the customer with a network address via which to contact the subscriber associated with the selected service option.

29. The computer-readable medium of claim 17 wherein the broker logic is operable to track customer rating of subscribers.

30. The computer-readable medium of claim 21 wherein information includes an indication of rating of a subscriber by at least one previous customer.

31. The computer-readable medium of claim 17 wherein at least one service offering includes search hint terms.

32. The computer-readable medium of claim 32 wherein the broker logic is further operable to utilize the search hint terms to identify the at least one subscriber in response to the customer inquiry.

33. A method for facilitating provision of customer service to a customer comprising:
accepting service offerings from multiple subscribers via a broker device, including, for each subscriber, recording an indication of proficiency in different skills; and
responding to an inquiry from the customer received by a primary contact center by signaling to signal to the broker device,
the broker device operating in response to the primary contact center to identify at least one subscriber having relatively greater proficiency than other subscribers in skills required to respond to the inquiry, and providing to the primary contact center an indication of the identified subscribers,
the primary contact center operating in response to the broker device to present service option information associated with the identified subscribers to the customer.

34. The method of claim 33 further including initiating the inquiry by an application on a computer operated by the customer.

35. The method of claim 33 further including tracking service options presented to the customer with an accounting module.

36. The method of claim 33 further including tracking service options selected by the customer with an accounting module.

37. The method of claim 34 further including the primary contact center prompting the application to render a help screen window having a service option selector icon populated based on the information provided by the primary contact center.

38. The method of claim 37 further including providing information including an indication of service availability.

39. The method of claim 37 further including providing information including an indication of fees charged to the customer for the service.

40. The method of claim 37 further including providing information including an indication of media of delivery of the service.

41. The method of claim 33 further including the primary contact center operating in response to selection of a service option by the customer to set up a telephone connection between the customer and the subscriber associated with the selected service option.

42. The method of claim 33 further including the primary contact center operating in response to selection of a service option by the customer to provide the customer with a telephone number via which to contact the subscriber associated with the selected service option.

43. The method of claim 33 further including the primary contact center operating in response to selection of a service option by the customer to provide the subscriber associated with the selected service option with a telephone number via which to contact the customer.

44. The method of claim 33 further including the primary contact center operating in response to selection of a service option by the customer to provide the customer with a network address via which to contact the subscriber associated with the selected service option.

45. The method of claim 33 further including the broker device tracking customer rating of subscribers.

46. The method of claim 38 further including providing information which includes an indication of rating of a subscriber by at least one previous customer.

47. The method of claim 33 wherein at least one service offering includes search hint terms.

48. The method of claim 48 further including the broker device utilizing the search hint terms to identify the at least one subscriber in response to the customer inquiry.
